(19) United States
(12) Patent Application Publication
(10) Pub. No.: US 2014/0300530 A1
(43) Pub. Date: Oct. 9, 2014

(54) DISPLAY APPARATUS

(71) Applicant: MITSUBISHI ELECTRIC CORPORATION, Tokyo (JP)

(72) Inventor: Zenichiro Hara, Chiyoda-ku (JP)

(73) Assignee: MITSUBISHI ELECTRIC CORPORATION, Chiyoda-ku, Tokyo (JP)

(21) Appl. No.: 14/351,919

(22) PCT Filed: Dec. 7, 2012
(86) PCT No.: PCT/JP2012/081782

§ 371 Date: Apr. 15, 2014

(30) Foreign Application Priority Data
Dec. 27, 2011 (JP) 2011-284691

(51) Int. Cl. G09G 3/32

(52) U.S. Cl. CPC G09G 3/32
USPC 345/83

(57) ABSTRACT

A display apparatus in which each pixel is made up of four sub-pixels in a 2×2 array and a display portion is formed by regularly arranging the pixels in a horizontal direction and a vertical direction is configured in such a manner that the four sub-pixels are formed of RGB three sub-pixels and remaining one sub-pixel that makes a dark area suppressing reflections, and that the pixels in odd-numbered rows or even-numbered rows in the display portion are moved by one sub-pixel in a horizontal direction or the pixels in odd-numbered columns or even-numbered columns are moved by one sub-pixel in a vertical direction so that the dark area may be disposed in a hound's tooth pattern.

### TECHNICAL FIELD

The present invention relates chiefly to a large-scale display apparatus formed by arranging a large number of display elements, such as LEDs, as pixels.

### BACKGROUND ART

FIG. 15 is a view used to describe a typical large-scale display apparatus. A display apparatus 10 is formed by arranging a large number of display units 5 in a tile fashion in a display portion 4. Each display unit 5 is formed by arranging sub-pixels 2, which are display elements, such as light emitting diodes (LEDs), in a lattice fashion. In order to display a full-color video, a large-scale display apparatus in the related art is formed by arranging pixels 1, each of which includes at least one sub-pixel 2 for each of R (Red), G (Green), and B (Blue), in a lattice fashion. Herein, the sub-pixels 2 are equivalent to individual LED elements 2.

In recent years, LEDs are the mainstream of the display elements of the large-scale display apparatus. Because locations and an arrangement pitch of LEDs of three primary colors can be designed arbitrarily, it becomes possible to form a large-scale display apparatus with resolution and brightness at various levels that best suit the applications. In particular, LEDs called 3-in-1 LEDs including LED chips of RGB three colors in one lamp are emerging these days. The large-scale display apparatus with LEDs arranged as above are devised in an LED arrangement method from the viewpoints of improving an image quality and reducing the cost. For example, methods as described in the literatures specified below are proposed.

### CITATION LIST

### Patent Literature

PTL 1: Japanese Patent No. 3702699

PTL 2: JP-A-2009-230096

### SUMMARY OF INVENTION

### Technical Problem

For the large-scale display apparatus in the related art to obtain high resolution, it is necessary to arrange the pixels at a high density by shortening a pixel pitch. Accordingly, for example, in the case of a high-resolution large-scale display apparatus formed by arranging LEDs, the cost is increased because the number of LEDs per unit area is increased. In particular, when the display apparatus is applied to a high-definition television to display high-definition contents with a high image quality, LEDs are arranged at a higher density and the cost is increased dramatically. At the same time, power consumption is increased more as the LEDs are arranged at a higher density.

The invention was devised to solve the problems discussed above and has an object to achieve a significant cost reduction or significant power saving of a large-scale display apparatus by appropriately arranging pixels. The term, “to appropriately arrange pixels”, referred to herein means to reduce the cost by reducing the number of pixels to be arranged while chiefly suppressing deterioration of an image quality to the minimum. A second object of the invention is to significantly reduce power consumption of a large-scale display apparatus when displaying a video at the same brightness by replacing a part of pixels to be arranged with a color having high luminance efficiency while suppressing deterioration of an image quality to the minimum.

### Solution to Problem

A display apparatus according to the invention is a display apparatus in which each pixel is made up of four sub-pixels in a 2×2 array and a display portion is formed by regularly arranging the pixels in a horizontal direction and a vertical direction. The four sub-pixels are formed of RGB three sub-pixels and remaining one sub-pixel, and the pixels in odd-numbered rows or even-numbered rows in the display portion are moved by one sub-pixel in a horizontal direction or the pixels in odd-numbered columns or even-numbered columns are moved by one sub-pixel in a vertical direction.

Also, a display apparatus according to the invention is a display apparatus in which each pixel is made up of four sub-pixels in a 2×2 array and a display portion is formed by regularly arranging the pixels in a horizontal direction and a vertical direction. Each pixel has 3-in-1 elements each including three primary colors as up to three sub-pixels, and the pixels in odd-numbered rows or even-numbered rows in the display portion are moved by one sub-pixel in a horizontal direction or the pixels in odd-numbered columns or even-numbered columns are moved by one sub-pixel in a vertical direction.

### Advantageous Effects of Invention

According to the invention, by arranging pixels appropriately, the number of pixels to be arranged is reduced, so that the cost can be reduced while chiefly suppressing deterioration of an image quality to the minimum. Also, by replacing apart of the pixels to be arranged with a color having high luminance efficiency, power consumption of a large-scale display apparatus when displaying a video at the same brightness can be reduced markedly while suppressing deterioration of an image quality to the minimum.

### BRIEF DESCRIPTION OF DRAWINGS

FIG. 1 is a view used to describe a lattice-like pixel arrangement as a precondition for the invention.

FIG. 2 is a view used to describe a lattice-like pixel arrangement describing an idea underlying the invention.

FIG. 3 is a typical pixel arrangement as a precondition for the invention.

FIG. 4 is a view showing a pixel arrangement of a display apparatus according to a first embodiment of the invention.

FIG. 5 is a view used to describe resolution of B or R in FIG. 3.

FIG. 6 is a view used to describe resolution of B or R in FIG. 4.

FIG. 7 is a view showing an example of a pixel arrangement in which black is inserted as a precondition for a display apparatus according to a second embodiment of the invention.

FIG. 8 is a view showing another example of the pixel arrangement in which black is inserted as a precondition for the display apparatus according to the second embodiment of the invention.

FIG. 9 is a view showing a pixel arrangement of the display apparatus according to the second embodiment of the invention.

FIG. 10 is a view used to describe resolution of FIG. 8.

FIG. 11 is a view showing a pixel arrangement of the display apparatus according to the second embodiment of the invention.

FIG. 12 is a view showing a pixel arrangement of a display apparatus according to a third embodiment of the invention.

FIG. 13 is a view showing an example of a pixel arrangement as a precondition for a fourth embodiment of the invention.

FIG. 14 is a view showing a pixel arrangement of a display apparatus according to the fourth embodiment of the invention.

FIG. 15 is a perspective view of a typical large-scale display apparatus.

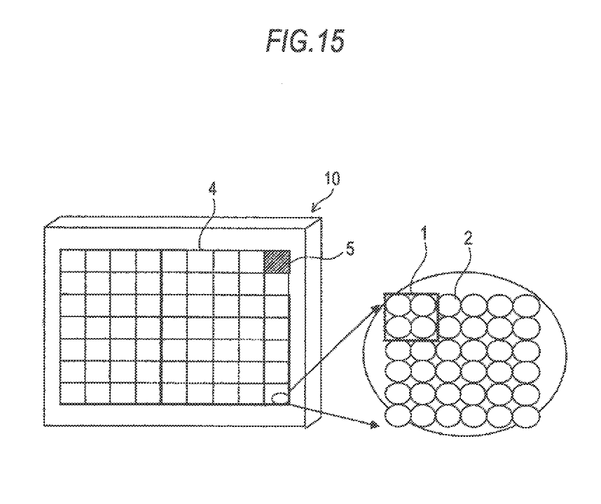

### DESCRIPTION OF EMBODIMENTS

Hereinafter, the invention will be described according to embodiments. Herein, a description of the typical configuration of a display apparatus will be omitted and a description will be given chiefly to a pixel arrangement.

### First Embodiment

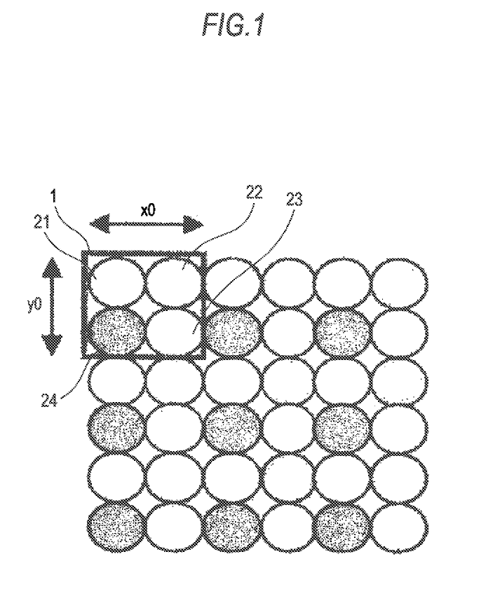

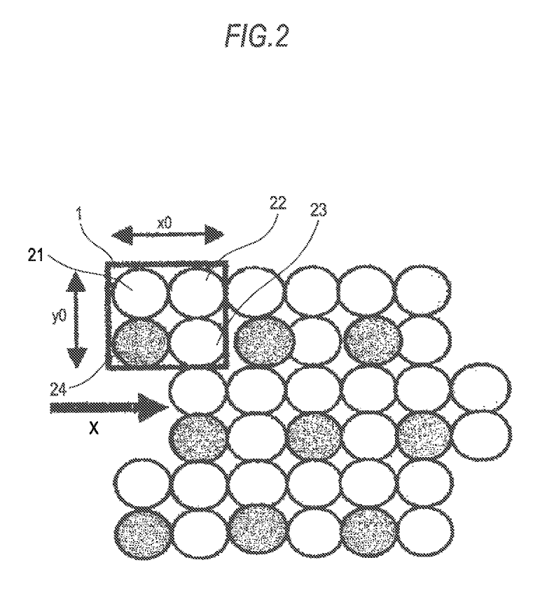

A fundamental idea underlying the invention will be described using FIG. 1 and FIG. 2. FIG. 1 shows such an example that in a display apparatus formed by arranging pixels 1 in a lattice fashion, one pixel 1 is made up of four sub-pixels (for example, four LED elements) in a 2×2 array forming a basic lattice and the pixels 1 are further arranged in a lattice fashion. As at least one sub-pixel out of four sub-pixels 21 through 24 making up each pixel 1, the sub-pixel 24 of a different color from the rest is located. A lateral pitch of the pixels 1 is denoted as x0 and a longitudinal pitch as y0.

FIG. 2 shows an example when pixels in an even-numbered row of FIG. 1 are moved by one sub-pixel in a direction indicated by an arrow X (rightward in a horizontal direction in the drawing). In FIG. 1, the sub-pixels 24 are arranged discretely in a lattice fashion. On the contrary, the sub-pixels 24 are arranged in a zigzag fashion in FIG. 2. When flickering by the lattice-like sub-pixels 24 and flickering by the zigzag-like sub-pixels 24 are compared, flickering by the zigzag-like sub-pixels 24 is less noticeable because human sight is generally less sensitive to a diagonal direction in comparison with a horizontal or vertical direction. An image quality thus tends to be improved.

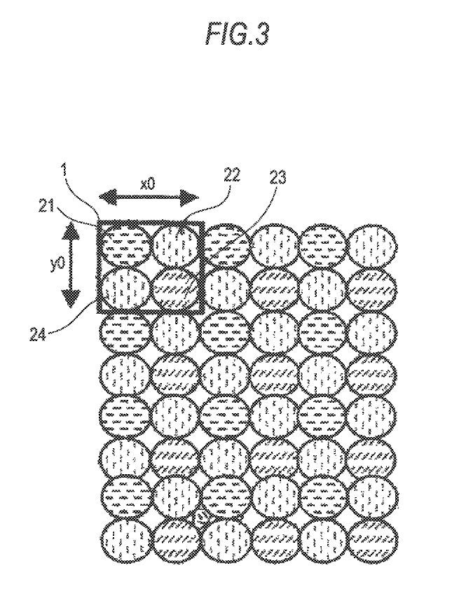

A practical application will now be described on the basis of the fundamental idea as above. FIG. 3 shows a typical pixel arrangement applied to a display apparatus. Of the four sub-pixels making up one pixel 1, RGB three colors are assigned to the sub-pixels 21 through 23 and G is additionally assigned to the sub-pixel 24. PTL 1 discloses an example in which R is added as a fourth color. The pixel arrangement of the image apparatus can have diversified variations on the basis of this method.

Referring to FIG. 3, R and B are fewer than G and G assigned to the sub-pixels 24 corresponds to the sub-pixels 24 of FIG. 1 and are therefore arranged discretely in a lattice fashion. Hence, in the case of an R or B monochromatic display, arrays of R or B arranged every other sub-pixel in a lattice fashion tend to be more noticeable as flickering.

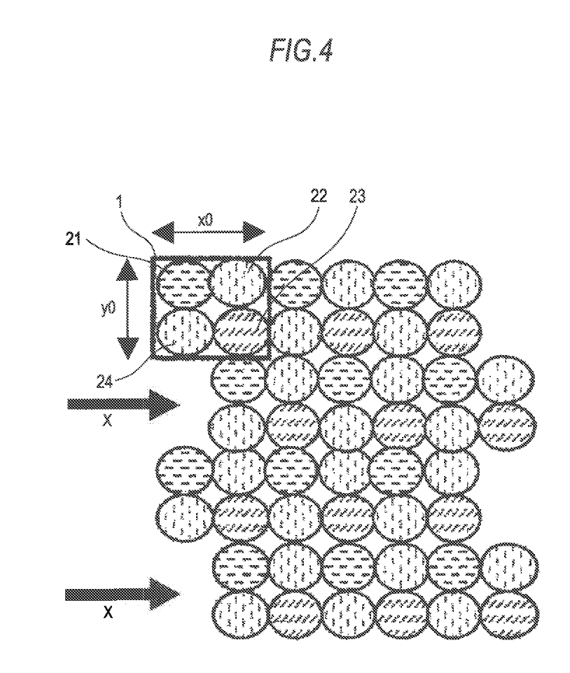

FIG. 4 shows a pixel arrangement of the display apparatus according to the first embodiment of the invention. Herein, odd-numbered (or even-numbered) rows (or columns) in the pixel arrangement are moved by one sub-pixel in units of pixels in the lateral direction (or longitudinal direction). FIG. 4 shows an example in which even-numbered rows of FIG. 3 are moved by one sub-pixel (=x0/2) in units of pixels in a direction indicated by an arrow X (rightward in the horizontal direction in the drawing). The pixels are arranged in a zigzag fashion in an R or B monochromatic display and flickering is lessened in comparison with a lattice-like arrangement.

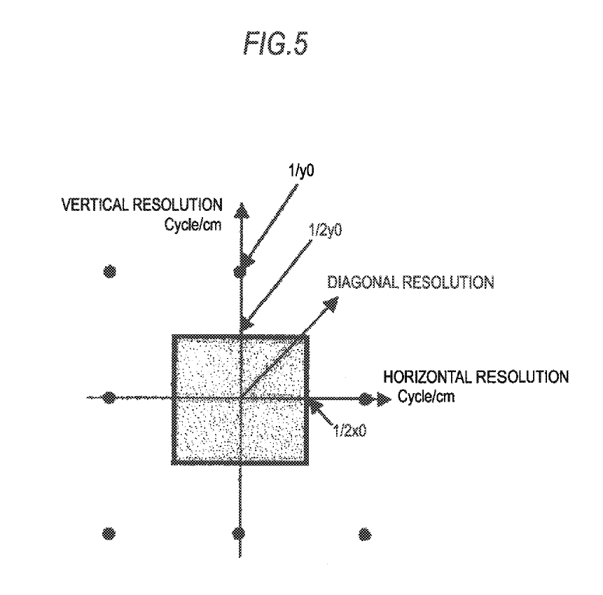

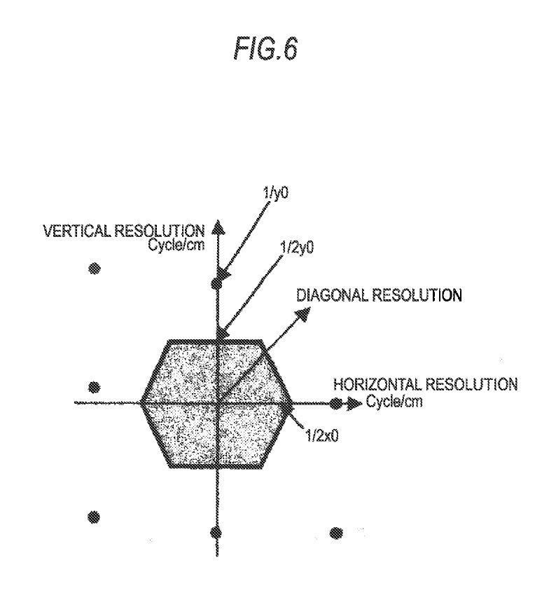

FIG. 5 and FIG. 6 show resolution of B or R in FIG. 3 and FIG. 4, respectively. The abscissa is used for horizontal resolution and the ordinate is used for vertical resolution. FIG. 6 indicates that the horizontal resolution tends to be slightly improved in comparison with FIG. 5 at the slight sacrifice of resolution of a diagonal component of an image. Herein, although the location of G varies, G outnumbers B or R from the start. Hence, an image quality is not limited by influences of flickering by G and resolution thereof.

The above has described an example with reference to FIG. 4 in which G is added as a color of the fourth sub-pixel 24 to the RGB three sub-pixels 21 through 23. It should be noted, however, that in another example in which R is added instead of G, the same advantage can be achieved by moving the pixels in the same manner. Also, the above has described an example with reference to FIG. 4 in which odd-numbered rows or even-numbered rows are moved by one sub-pixel in the horizontal (lateral) direction. It should be noted, however, that similar satisfactory result can be obtained in terms of flickering by moving pixels in odd-numbered columns or even-numbered columns by one sub-pixel (=y0/2) in a vertical (longitudinal) direction.

### Second Embodiment

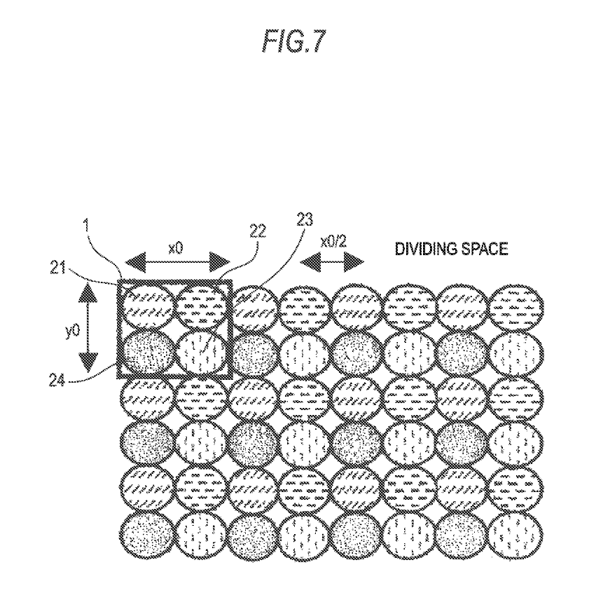

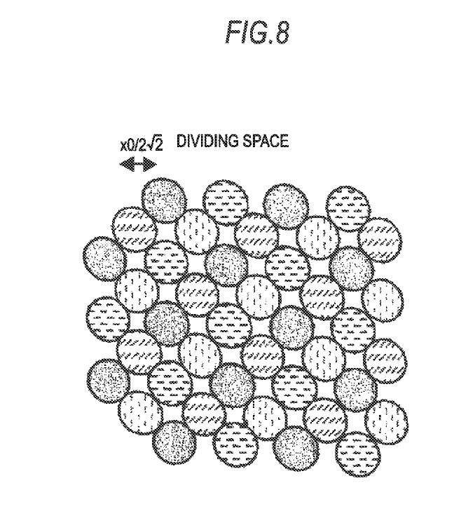

Firstly, FIG. 7 and FIG. 8 as a precondition for a second embodiment of the invention will be described. FIG. 7 shows an example in which black is located as a color of the fourth sub-pixel 24 in FIG. 3 in which the sub-pixels 21 through 24 are arranged in a lattice fashion. Black is obtained by turning a space made by omitting one sub-pixel into black. By providing the space with an opening member forming a recessed portion with respect to the display surface, satisfactory black is obtained by suppressing irradiation or reflection of outside light. Hence, there can be achieved an advantage of improving contrast in terms of an image quality. PTL 2 discloses, as a similar example, a novel pixel arrangement by which the pixel arrangement of FIG. 7 is further rotated by 45° as is shown in FIG. 8. In both FIG. 7 and FIG. 8, a black level across the screen is lowered in comparison with FIG. 3 by omitting one sub-pixel out of four sub-pixels and turning the sub-pixel omitted portion into black. More specifically, black on the screen is turned to black at lower brightness. Hence, contrast of a display is improved and also a color reproducible range is expanded. In FIG. 8, horizontal and vertical resolutions tend to be improved by rotating the pixel arrangement of FIG. 7 by 45°. In addition, the pixel-omitted portions (black) in FIG. 8 are arranged not in a lattice fashion of FIG. 3 but in a zigzag fashion. Hence, noticeability as a noise tends to be lessened.

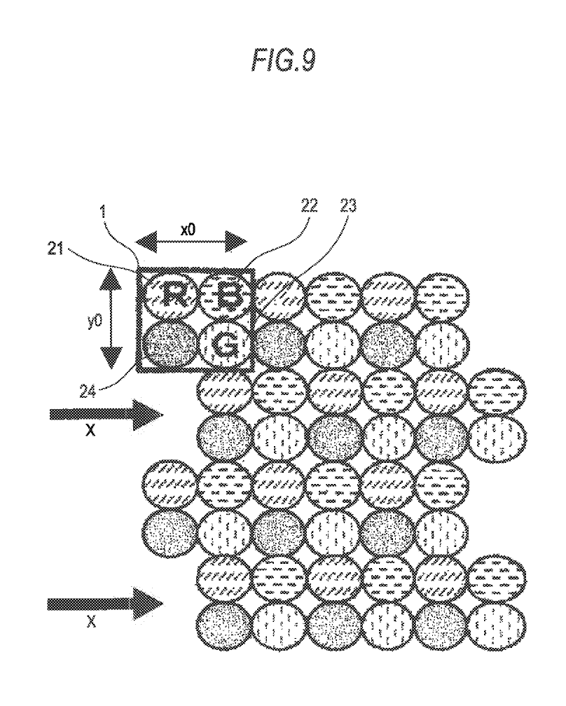

FIG. 9 shows a pixel arrangement according to the second embodiment of the invention. The pixel arrangement shown in FIG. 9 overcomes the problems of FIG. 7 and FIG. 8 and has the characteristics as follows. That is, in comparison with FIG. 7 in which one sub-pixel is merely omitted, pixels in even-numbered rows are moved by one sub-pixel in a direction indicated by an arrow X (rightward in the horizontal direction in the drawing) in FIG. 9. As a result, in contrast to FIG. 7 in which the pixel-omitted portions (black) are arranged in a lattice fashion, the pixel-omitted portions (black) are arranged in a zigzag fashion in FIG. 9. Consequently, noises caused by the pixel structure become less noticeable and horizontal resolution is slightly improved.

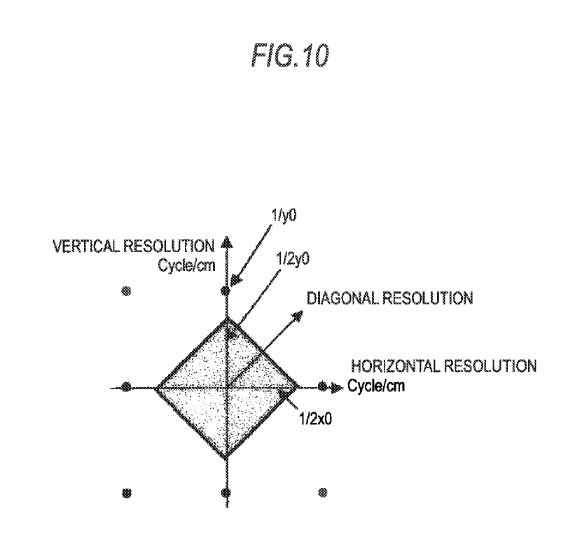

Subsequently, FIG. 9 is compared with FIG. 8 in which the display portion is rotated by 45°. A region corresponding to the resolution of FIG. 8 is shown in FIG. 10. In FIG. 10, FIG. 5 rotated by 45° is shown and diagonal lines are sacrificed. However, horizontal resolution and vertical resolutions are improved. Further, noticeability as noises caused by the pixel structure is lessened. Hence, this pixel arrangement has preferable characteristics in terms of an image quality. On the other hand, from the viewpoint of the structure, it becomes difficult to secure a dividing space needed to divide the display portion into display units. For example, with the structure of FIG. 1 through FIG. 4, x0/2 can be secured as a dividing space whereas the dividing space is narrowed to x0/2√2 in FIG. 8. In contrast, with the pixel arrangement of FIG. 9, x0/2 can be secured as a dividing space as with FIG. 1 through FIG. 4. Hence, in addition to the advantages of reducing the cost and improving the contrast as with FIG. 7 and FIG. 8, the pixel arrangement of FIG. 9 achieves an advantage of lessening noises on the screen. Further, the pixel arrangement is of a structure easily divided to units and suitable to obtain further higher resolution by narrowing a pixel pitch.

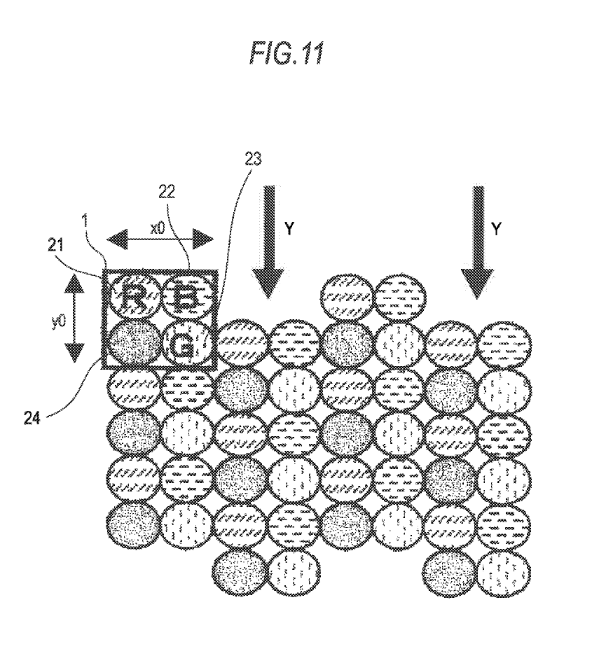

FIG. 11 shows a result obtained by moving the sub-pixels 21 through 24 (R, G, B, and Black) of FIG. 7 in which one sub-pixel is merely omitted by one dot in a direction indicated by an arrow Y (downward in the vertical direction in the drawing). FIG. 11 has substantially the same advantages as those of FIG. 9. However, in contrast to FIG. 9 in which the horizontal resolution is slightly improved in comparison with FIG. 7, the vertical resolution is slightly improved in FIG. 11.

### Third Embodiment

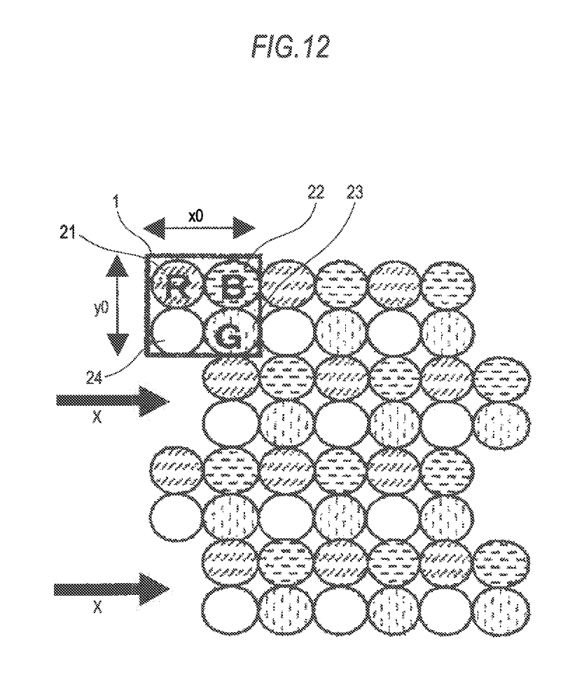

FIG. 12 shows a pixel arrangement according to a third embodiment of the invention. The third embodiment is characterized in that the black sub-pixels 24 of FIG. 7 are replaced with white and that even-numbered rows in the pixel arrangement are moved by one sub-pixel in units of pixels in a direction indicated by an arrow X (rightward in the horizontal direction in the drawing). This pixel arrangement corresponds to a pixel arrangement in which the color of the sub-pixel 24 out of the sub-pixels 21 through 24 of FIG. 9 is changed from black to white. By merely replacing one sub-pixel 24 in lattice-like pixels with white, white arranged in a lattice fashion becomes noticeable as noises. However, white is arranged in a zigzag fashion in FIG. 12 and noises are thus lessened. Further, by locating white having high luminance efficiency in a part of the pixels, although the cost is increased by adding white in comparison with FIG. 9 in which black is located, the entire screen becomes brighter and power required for light emission at the same brightness is thus reduced markedly. The above has described an example with reference to FIG. 12 in which even-numbered rows in the pixel arrangement are moved in the horizontal direction. It should be noted, however, that the even-numbered columns can be moved in the vertical direction as in FIG. 11, in which case vertical resolution is slightly improved.

### Fourth Embodiment

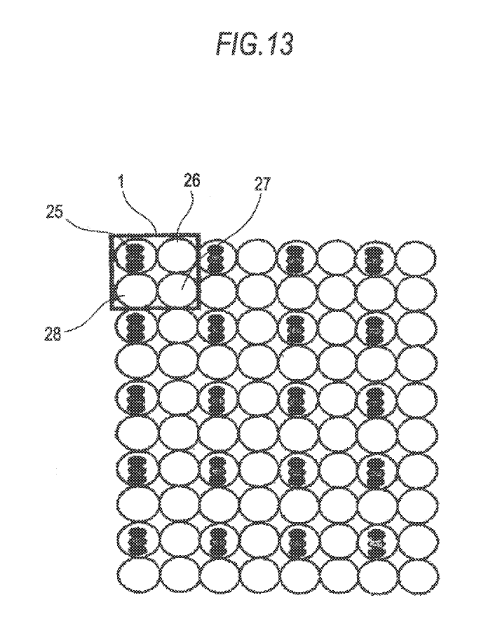

FIG. 13 is a view showing an example of a pixel arrangement as a precondition for a fourth embodiment of the invention. A large-scale display apparatus using arrays of LEDs employs 3-in-1 elements including three primary colors in one element for applications with a short visual distance. Sub-pixels 25 formed of 3-in-1 elements are chiefly used indoors because three colors are readily mixed. Generally, the sub-pixels 25 are arranged in a lattice fashion and the cost can be reduced by replacing a part of sub-pixels 26 through 28 with inexpensive monochromatic elements. In FIG. 13, 3-in-1 elements each including three primary colors are used as single sub-pixels 25 in the lattice-like pixel arrangement of FIG. 1. Influences to an image quality given by replacing the three sub-pixels 26 through 28 other than the sub-pixels 25 with monochromatic elements can be lessened by securing a sufficient visual distance.

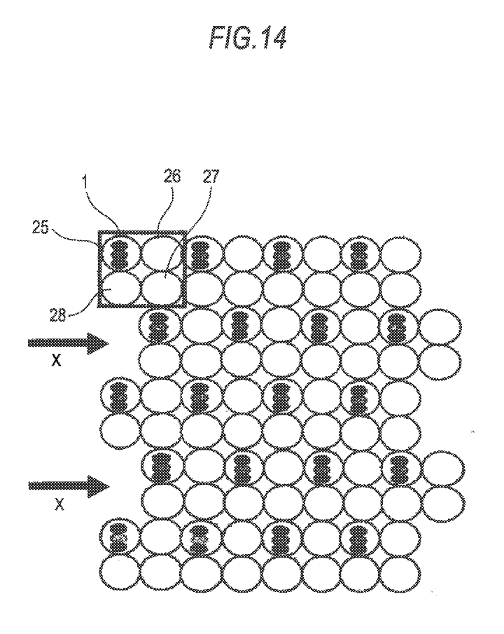

FIG. 14 shows a pixel arrangement according to the fourth embodiment of the invention, in which even-numbered rows in the pixel arrangement of FIG. 13 are moved by one sub-pixel in units of pixels in a direction indicated by an arrow X (rightward in the horizontal direction in the drawing). The sub-pixels arranged in a lattice fashion in FIG. 13 are arranged in a zigzag fashion. Accordingly, influences to an image quality given by replacing the sub-pixels 26 through 28 other than the sub-pixels 25 formed of 3-in-1 elements with monochromatic elements are lessened. It should be noted, however, that the same advantage can be achieved by moving odd-numbered or even-numbered columns in the pixel arrangement by one sub-pixel in a vertical direction.

In FIG. 14, one sub-pixel 25 out of four sub-pixels is formed of a 3-in-1 element. It should be appreciated, however, that two or three sub-pixels out of four sub-pixels may be formed of 3-in-1 elements. Further, the sub-pixels 26 through 28 out of the four sub-pixels other than the 3-in-1 element can be white. Because white has high luminance efficiency, brightness across the screen becomes higher by locating white. Hence, when power consumption is compared at the same brightness, power can be saved markedly in addition to a cost reduction.

### REFERENCE SIGNS LIST

1: pixel
2: display element
4: display portion
5: display unit
10: display apparatus
21 through 24: sub-pixels
25 through 28: sub-pixels

1. A display apparatus in which each pixel is made up of four sub-pixels in a 2×2 array and a display portion is formed by regularly arranging the pixels in a horizontal direction and a vertical direction:
the four sub-pixels are formed of RGB three sub-pixels and remaining one sub-pixel that makes a dark area suppressing reflections;
the pixels in odd-numbered rows or even-numbered rows in the display portion are moved by one sub-pixel in a horizontal direction or the pixels in odd-numbered columns or even-numbered columns are moved by one sub-pixel in a vertical direction so that the dark area may be disposed in a hound's tooth pattern.

2. (canceled)

3. (canceled)

4. (canceled)

5. A display apparatus in which each pixel is made up of four sub-pixels in a 2×2 array and a display portion is formed by regularly arranging the pixels in a horizontal direction and a vertical direction, wherein:
each pixel has 3-in-1 elements each including three primary colors as up to three sub-pixels; and
the pixels in odd-numbered rows or even-numbered rows in the display portion are moved by one sub-pixel in a horizontal direction or the pixels in odd-numbered columns or even-numbered columns are moved by one sub-pixel in a vertical direction.

6. The display apparatus according to claim 5, wherein:
a color of the sub-pixel other than the sub-pixels formed of the 3-in-1 elements is monochrome.

7. The display apparatus according to claim 5, wherein:
a color of the sub-pixel other than the sub-pixels formed of the 3-in-1 elements is white.
